(19) United States
(12) Patent Application Publication
(10) Pub. No.: US 2012/0096886 A1
(43) Pub. Date: Apr. 26, 2012

(54) VEHICLE PERSONAL COOLING SYSTEM AND METHOD

(75) Inventor: Roger C. Palmer, Cleveland Heights, OH (US)

(73) Assignee: PARKER-HANNIFIN CORPORATION, Cleveland, OH (US)

(21) Appl. No.: 13/094,060

(22) Filed: Apr. 26, 2011

Related U.S. Application Data
(60) Provisional application No. 61/327,810, filed on Apr. 26, 2010.

(51) Int. Cl. B60H 1/32; F28F 27/00; F25D 17/06; F28D 15/00; F25B 1/00

(52) U.S. Cl. 62/244; 165/104.34; 165/41; 62/498; 62/419; 165/200

(57) ABSTRACT

A personal cooling system, such as for a cabless or other open-cab vehicle, includes a contact cooler that contacts the vehicle user, a forced-air cooler that directs cooled air to the vehicle user, and a recirculating fluid system that is operatively coupled to both the contact cooler and the forced-air cooler to provide cooling to both the contact cooler and the forced-air cooler. Contact cooling may be provided to the upper back of a vehicle user. Forced-air cooling may be provided on any of a number of areas of the user's body. The system may be able to detect the presence of a user in the seat. The detection of a user may trigger an initial relatively high level of cooling, which is followed after a predetermined time by a reduction of the level of cooling to a relatively low level of cooling.

This application claims the benefit under 35 USC 119 of U.S. Provisional Application 61/327,810, filed Apr. 26, 2010, which is incorporated by reference in its entirety.

### FIELD OF THE INVENTION

The invention is in the general field of cooling systems and methods for cooling vehicle users.

### DESCRIPTION OF THE RELATED ART

Currently, climate control technologies required to keep the operators and passengers comfortable during vehicle operation are very inefficient: these “closed loop” air conditioning systems account for as much as 10% of fuel consumption and essentially force the combustion engine in a hybrid vehicle to run far more often and for longer durations than would otherwise be required for routine operations. Some vehicles are required to have open cabs due to the need to hear audible cues in the environment (such as in construction work) and to permit frequent entry and exit of the vehicle (such as in delivery work and trash collection). Open cab or cab-less vehicles do not come with air conditioning.

### SUMMARY OF THE INVENTION

According to an aspect of the invention, a personal cooling system for a vehicle includes both a contact cooler and a forced-air cooler.

According to another aspect of the invention, a personal cooling system is used in an open cab vehicle, such as a cabless vehicle.

According to yet another aspect of the invention, a method of cooling includes operating a personal cooling system at a relatively high level of cooling for a time interval, and then reducing the cooling to a relatively low level of cooling.

According to still another aspect of the invention, a personal cooling system for a vehicle user includes: a contact cooler that contacts the vehicle user; a forced-air cooler that directs cooled air to the vehicle user; and a recirculating fluid system that is operatively coupled to both the contact cooler and the forced-air cooler to provide cooling to both the contact cooler and the forced-air cooler.

According to a further aspect of the invention, a method of cooling a user of an open-cab vehicle includes: providing a seat of the open-cab vehicle; and providing cooling to the user sitting in the seat, using a personal cooling system that is integrated with the seat.

According to a still further aspect of the invention, a method of cooling a user of a vehicle includes: detecting the user occupying a seat of the vehicle; upon detection of the user occupying the seat, providing a relatively high level of cooling to the user for a predetermined time interval, using a personal cooling system; and after the predetermined time interval, reducing the level of cooling provided by the personal cooling system to a relatively low level of cooling.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The appended drawings show various features of embodiments of the invention.

FIG. 1 is an oblique view of a cabless vehicle that includes a personal cooling system in accordance with an embodiment of the present invention.

FIG. 2 is a schematic diagram of a personal cooling system in accordance with an embodiment of the invention.

FIG. 3 is an oblique view of a personal cooling system integrated with a vehicle seat, in accordance with an embodiment of the invention.

FIG. 4 is a side view of the personal cooling system and seat of FIG. 3.

FIG. 5 is an oblique view of the personal cooling system and seat of FIG. 3, in a first configuration.

FIG. 6 is an oblique view of the personal cooling system and seat of FIG. 3, in a second configuration.

FIG. 7 is an oblique view of the personal cooling system and seat of FIG. 3, in a third configuration.

FIG. 8 is an oblique view of the personal cooling system and seat of FIG. 3, in a fourth configuration.

FIG. 9 is a chart showing various alternate embodiments of the present invention.

### DETAILED DESCRIPTION

A personal cooling system, such as for a cabless or other open-cab vehicle, includes a contact cooler that contacts the vehicle user, a forced-air cooler that directs cooled air to the vehicle user, and a recirculating fluid system that is operatively coupled to both the contact cooler and the forced-air cooler to provide cooling to both the contact cooler and the forced-air cooler. Contact cooling may be provided to the upper back of a vehicle user, such as by being integrated in a driver's seat of the vehicle. Forced-air cooling may be provided on any of a number of areas of the user's body, such as the head, chest, lower back, and/or pelvis. Some forced-air ducts may be attachable at different attachment points along the seat, to provide cooling to different parts of the user. The system may be able to detect the presence of a user in the seat, such as by a pressure-activated switch in the seat cushion. The detection of a user may trigger an initial relatively high level of cooling, which is followed after a predetermined time by a reduction of the level of cooling to a relatively low level of cooling. The open-loop personal cooling system provides cooling more efficiently than closed-loop systems that cool an entire environment, such as the closed cab of a vehicle. The personal cooling system may be especially advantageous for cabless vehicles, such as construction vehicles, or in open-cab vehicles that make frequent stops, such as delivery trucks.

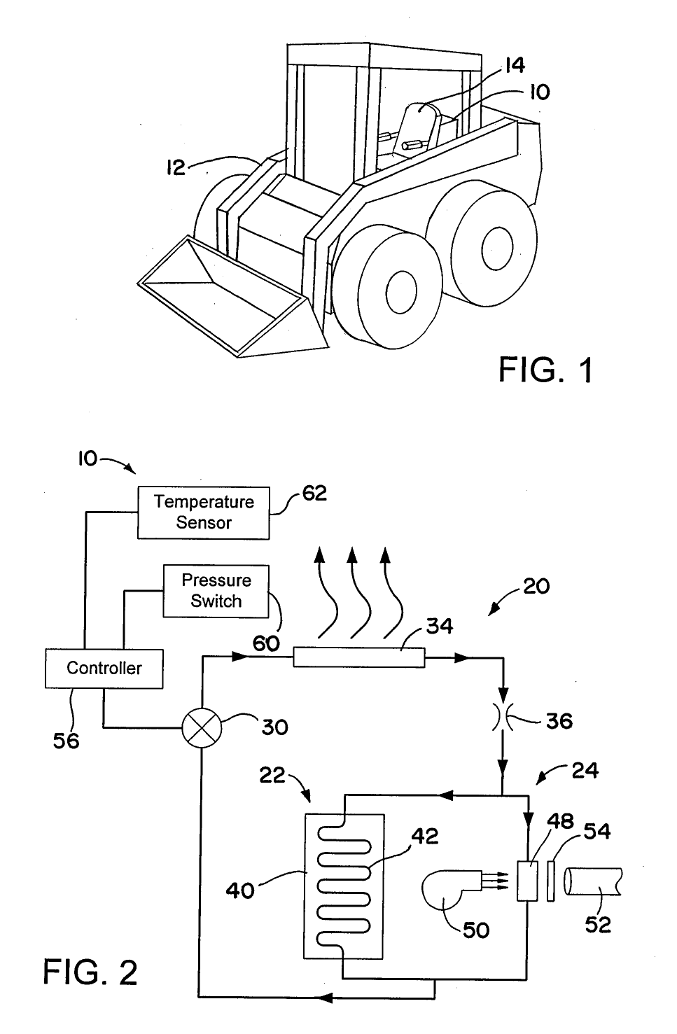

FIG. 1 shows a personal cooling system 10 that is part of a cabless vehicle 12. A “cabless vehicle,” as the phrase is used herein, refers to a vehicle which does not have a cab that encloses a user of the vehicle, such as a driver. A cabless vehicle may have a cover to protect the driver's head, but will be open for the most part at the level of the user, for example having open sides under a cover. Examples of cabless vehicles include some types of construction vehicles, farm vehicles, and maintenance vehicles. In addition the personal cooling system 10 may alternatively be used in open-cab vehicles, which as used herein refers to the broader category of vehicles that have a cab that has a substantial opening to the outside environment, such as an open window or door, a large amount of time, either continuously or periodically on a frequent basis. Examples include mail delivery vehicles, which have a window continuously open, and package delivery and trash collection vehicles, which may have an open door area, and may require an operator to enter and exit from the vehicle at frequent intervals. The category of open-cab vehicles is broader than the category of cabless vehicles, and includes cabless vehicles.

The personal cooling system 10 is integrated with a seat 14 of the vehicle 12, such as for use by an operator of the vehicle 12. The personal cooling system 10 provides concentrated cooling to various parts of the user's body. This enables cooling to be provided in an open environment, one in which a climate-controlled environment, such as an enclosed cab, is unavailable.

Referring now to FIG. 2, the cooling system 10 includes a recirculating fluid system 20 that provides cooling. The recirculating fluid system 20 is a closed loop refrigeration system that utilizes a suitable refrigerant as its working fluid, for example using R134a or R1234yf. The recirculating fluid system 20 provides cooling to a contact cooler 22 and a forced-air cooler 24. As explain in greater detail below, the contact cooler 22 and the forced-air cooler 24 are used to cool certain parts of the user's body.

The recirculating fluid system 20 includes a compressor 30 that pressurizes and circulates the working fluid. The pressurized hot vapor that is output from the compressor 30 passes through a heat exchanger 34 in which the working fluid is cooled into a liquid state. Any of a variety of suitable known heat exchanger configurations may be utilized. Heat is rejected from the heat exchanger 34 by air that flows past the heat exchanger 34. The air flow may be due to natural convection, or may include forced convection. The forced convection may be due to a fan or blower (not shown) blowing air past the heat exchanger 34. Alternatively or in addition the forced convection may be produced by movement of the vehicle 12, such as by driving the vehicle 12 from one location to another.

The liquid working fluid emerging from the heat exchanger 34 passes through an expansion device 36. The expansion device may be any of a variety of suitable metering devices, such as an orifice, expansion valve, or capillary tube. The expansion device 36 lowers the pressure of the liquid refrigerant working fluid.

The low pressure liquid output by the expansion device 36 then is used to cool the contact cooler 22 and the forced-air cooler 24. The contact cooler 22 includes a cooling plate 40 that is cooled by running the working fluid through a serpentine passage 42 so that the working fluid is in thermal contact with and cools the cooling plate 40. In doing so the working fluid heats up and may change from liquid at the input of the passage 42, to vapor at the output of the passage 42. The passage 42 may thus be part of an evaporator that provides cooling to the cooling plate 40.

Another portion of the working fluid may be directed into an additional heat exchanger 48, used for cooling air in the forced-air cooler 24. The forced-air cooler 24 includes a fan 50 that blows air over the additional heat exchanger 48, and into ducts 52. The ducts 52 are used to direct the cooled air to various body parts of the seated user. The ducts 52 may have respective valves 54 for shutting off or restricting flow of cold air. This allows the user to exercise control over the location and/or amount of forced-air cooling. The working fluid that passes through the additional heat exchanger 48 may also heat up and change from liquid to vapor.

The vapor from the passage 42 and the additional heat exchanger 48 is then returned to the compressor 30. At the compressor 30 the cycle begins anew.

Power for operation of the personal cooling system 10 may be provided by any of a variety of suitable sources. The power may be electrical, hydraulic, pneumatic, or from a combustion engine. The operation of the personal cooling system 10 may be controlled by a controller 56. The controller 56 may include an integrated circuit or other suitable control device that controls the providing of power to powered parts of the system 10, such as the compressor 30 and the fan 50. The controller 56 may also control the parameters of operation, such as the pressure and flow within the recirculating fluid system 20, so as to control the amount of cooling output by the personal cooling system 10.

The controller 56 may receive inputs that may be used to determine whether and at what load to operate the personal cooling system 10. The inputs may include a pressure switch 60 and a temperature sensor 62. The pressure switch 60 may be located in or on a seat cushion of the seat 14 (FIG. 1), and may be used to initiate operation of the personal cooling system 10. As explained in greater detail below, upon detection of the user occupying the seat 14, the personal cooling system 10 may initially operate at a relatively high level of cooling for a predetermined time interval, and then may reduce the level of cooling to a relatively low level of cooling.

The pressure switch 60 may also incorporate a strain gage, for example to allow the controller 56 to use weight of the occupant of the seat 14 as an input in determining the level of cooling that is utilized. The greater the weight of the occupant, the more cooling that may be provided.

The temperature sensor 62 may provide input to the controller 56 concerning the local ambient air temperature, or another suitable temperature. The operation of the personal cooling system 10, such as the amount of cooling output, may be a function of the information provided by the temperature sensor 62.

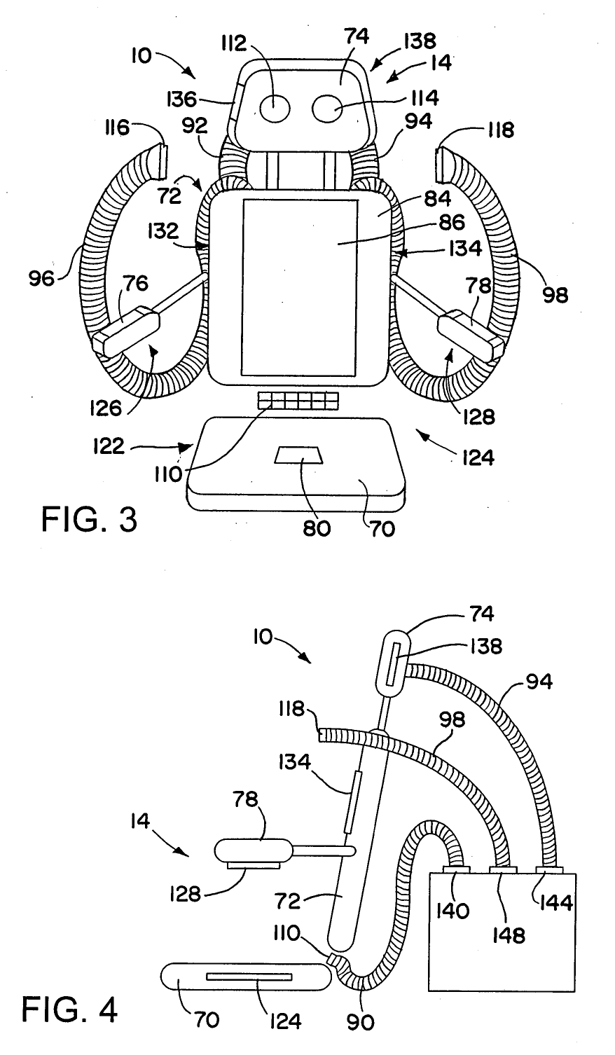

With reference now to FIGS. 3 and 4, an embodiment of the personal cooling system 10 is integrated with the seat 12. The seat 12 includes a seat cushion 70 for a user to sit on, and a seat back 72 for the user to rest his or her back against. A head rest 74 supports the user's head, and a pair of armrests 76 and 78 are configured for receiving and supporting the user's arms. The seat cushion 70 has a pressure switch 80 incorporated into it, to allow detection of when a vehicle user is in the seat 12.

The contact cooler 22 includes a back rest cooling plate 84 that is operatively coupled to the recirculating fluid system 20, to allow cooling fluid from the recirculating fluid system 20 to cool the contact cooler 22. The back rest cooling plate 84 may have a passage in it (not shown) that receives cooling fluid from the recirculating fluid system 20 through a tube or duct (not shown). The back rest cooling plate 84 may be made of a suitable metal, such as steel, that conducts heat well. A removable back rest insulator 86 may be placed over the back rest cooling plate 84, for example to prevent direct contact between the user's back and the back rest cooling plate 84. Since the back rest cooling plate 84 may become very cold when the personal cooling system 10 is running, it may be desirable for the user to avoid the sudden chill of direct contact with the highly conductive back rest cooling plate 84. In addition, the back rest insulator 86 may be softer than the metal back rest cooling plate 84, providing some degree of padding for a user to rest his or her back against. The back rest insulator 86 may include any of a variety of suitable materials, for example including a polymer foam. The back rest insulator 86 may be held in place on the back rest cooling plate 84 by any of a variety of suitable mechanisms, for example by use of VELCRO tabs.

The forced-air cooler 24 includes a series of ducts 90-98 that direct forced cold air from the recirculating fluid system 20 to various points around the seat 14. A fixed seat duct 90 directs air to a fixed seat vent 110 that provides cooling to the lower back or pelvis of a seat occupant. The fixed seat vent 110 is located between the seat cushion 70 and the seat back 72. The fixed seat vent 110 may have its output directed diagonally forward and upward.

A pair of head rest ducts 92 and 94 direct forced cold air from the recirculating fluid system 20 to head rest vents 112 and 114, which are located in the head rest 74. The head rest vents 112 and 114 direct air out of the head rest 74 and forward toward the head of the user.

A pair of movable ducts 96 and 98 terminate in vents 116 and 118 that can be located at different vent attachment points on the seat 14. The possible vent attachment points for locating the vents 116 and 118 include seat vent attachment points 122 and 124, armrest vent attachment points 126 and 128, back rest vent attachment points 132 and 134, and head rest vent attachment points 136 and 138. The vents 116 and 118 may be selectively and reversibly coupled to the various attachment points 122-138 using any of a variety of suitable mechanical mechanisms. For example the vents 116 and 118 may have protrusions that clip or slide into slots or recesses in the attachment points 122-138. The coupling mechanism may be made of metal and/or plastic, for example. More permanent coupling mechanisms, for example involving threaded fasteners, are also possible.

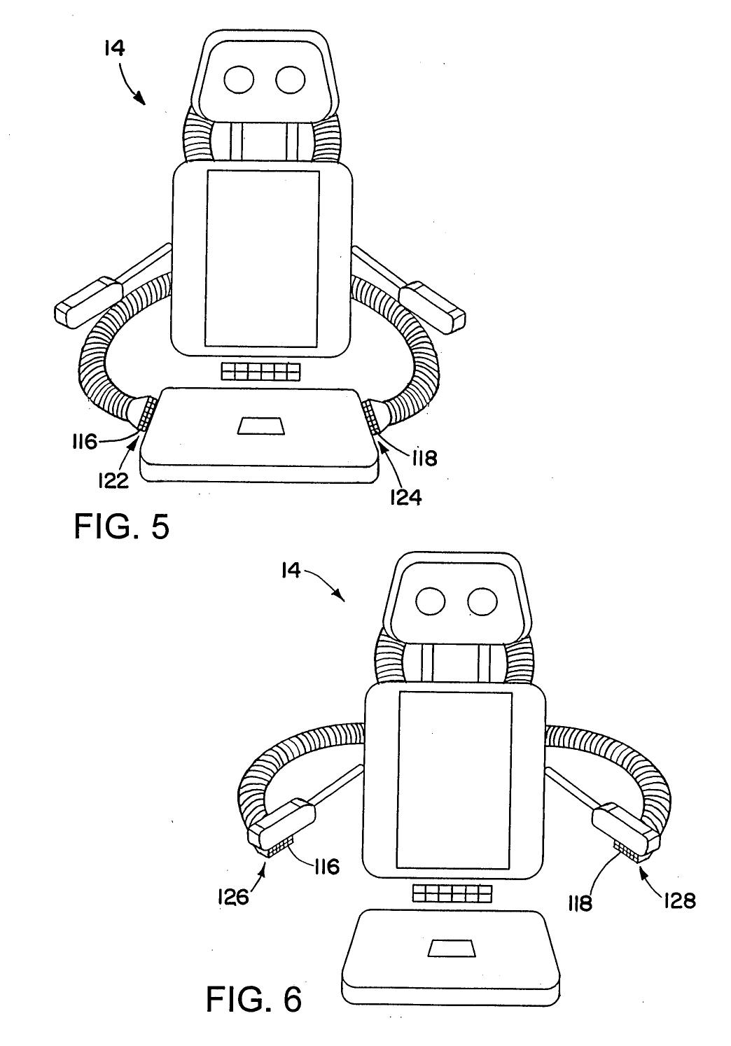

The seat vent attachment points 122 and 124 are on opposite sides of the seat cushion 70. FIG. 5 shows the vents 116 and 118 coupled to the seat vent attachment points 122 and 124, with air flow from the vents 116 and 118 directed upward and inward, to cool the upper legs of the seat occupant.

The armrest vent attachment points 126 and 128 are on bottom surfaces of the armrests 76 and 78. FIG. 6 shows the vents 116 and 118 coupled to the armrest vent attachment points 126 and 128, with air flow from the vents 116 and 118 directed inward, to cool the upper legs and lower chest of the seat occupant.

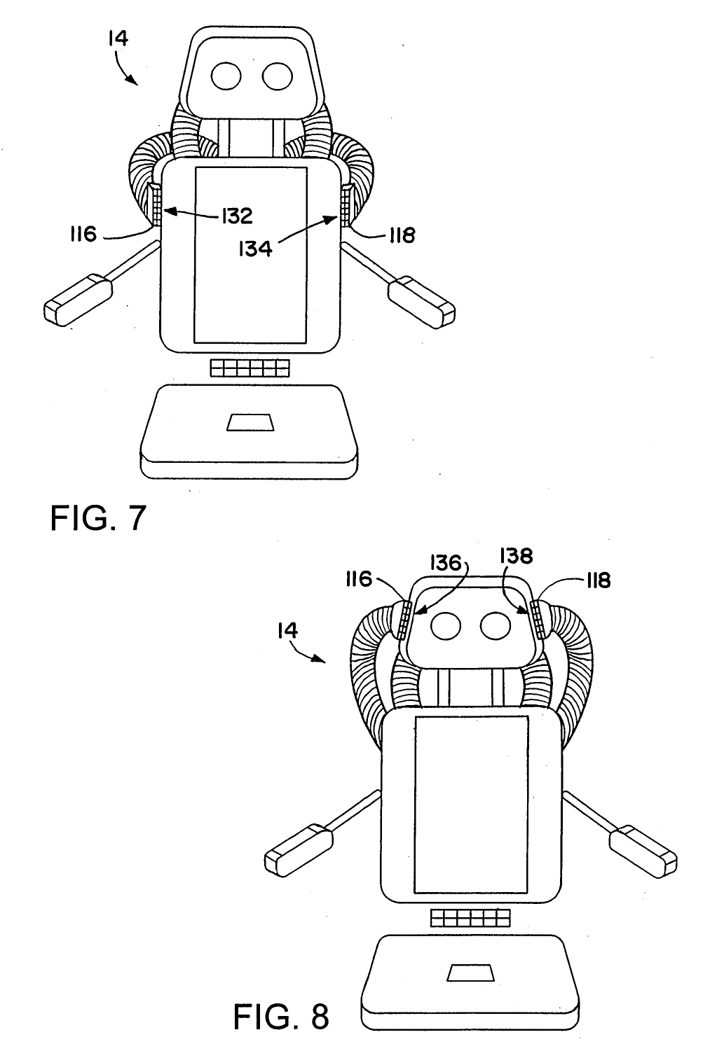

The back rest vent attachment points 132 and 134 are on opposite sides of the seat back 72. FIG. 7 shows the vents 116 and 118 coupled to the back rest vent attachment points 132 and 134, with air flow from the vents 116 and 118 directed inward and forward, to cool the upper chest of the seat occupant.

The head rest vent attachment points 136 and 138 are on opposite sides of the head rest 74. FIG. 8 shows the vents 116 and 118 coupled to the head rest vent attachment points 136 and 138, with air flow from the vents 116 and 118 directed inward and forward, to cool the head of the seat occupant.

Placement of the vents 116 and 118 at any of a variety of the vent attachment points 126-138 allows versatility in directing the cooling of the forced-air cooler 24. An end user may be able to configure the system 10 by moving the movable vents 116 and 118 to suit his or her preferences for cooling. Alternatively, the vents 116 and 118 may be placed at least semi-permanently at certain attachment points, not to be easily reconfigured by an end user.

Each of the ducts 90-98 may have a corresponding vent shut-off valve that allows flow to be constricted or shut off in that duct. The shut-off valves may be metal plates that may slide within a slot to partially or fully block or unblock a passage in or to the corresponding duct. FIG. 4 shows valves 140, 144, and 148, which can be used to control flow through the ducts 90, 94, and 98. The ducts 92 and 96 also have corresponding shut-off valves (not shown).

In use the personal cooling system 10 may be automatically turned on when a user first sits down in the seat 14. The system 10 may provide an initial burst of relatively high level rapid cooling for a predetermined time interval, and reduce the level of cooling to a relatively low level of cooling. The relatively low level of cooling may be maintained thereafter, as long as the pressure switch 80 still detects the presence of a user on the seat cushion 70. The rapid cooling enables rapid reduction in the user's perception of heat when he/she first returns to the vehicle, for example after making a delivery. In a high-temperature environment rapid cooling after performing a task outside is especially welcome.

In addition the user of the pressure switch 80 allows selective operation of the cooling system 10, with the system 10 operating only when the seat 14 is occupied. The selective operation could be applied in situations where there are multiple seats with multiple potential occupants, such as in a car, truck, or bus.

The relatively high level of cooling may be at least 0.75 tons (2.6 kW) of cooling, may be at least 1 ton (3.5 kW) of cooling, or may be from 0.75 tons (2.6 kW) to 1 ton (3.5 kW) of cooling. The relatively low level of cooling may be 0.5 tons (1.4 kW) of cooling or less, may be 0.33 tons (1.2 kW) of cooling or less, may be 0.25 tons (0.88 kW) of cooling or less, or may be in ranges between any of these values. These values may be a function of the temperature (such as outdoor temperature) that is obtained by the temperature sensor 62 (FIG. 2), and/or the function of the weight of the seat occupant, such as determined by a strain gage (which may be incorporated into the pressure switch 80). The time interval may be from 30 seconds to 120 seconds.

The level of cooling provided may be a function of such factors as the outside (ambient) temperature, and/or the weight of the seat occupant. The latter may be determined, for example, from a strain gage on the seat 14, such as a strain gage incorporated into the pressure switch 80, as described above. The level of cooling that is a function of the factor(s) may be the relatively high level or cooling and/or the relatively low level of cooling. As a further alternative, the cooling may be performed at a single constant cooling level, which may be factors such as the outside (ambient) temperature, and/or the weight of the seat occupant.

Directed cooling as described herein allows for specific cooling of torso, neck, and head regions for the vehicle operator and passengers, keeping them comfortable while using only a small fraction of the energy required by more conventional, “closed loop” systems, for example only one-sixth of the energy used by corresponding closed loop systems. Therefore applications for the system descried herein may extend beyond cabless and open-cab vehicles. Hybrids as a class of vehicles cannot succeed if the operator comfort and safety are not comparable to conventional solutions. To transplant the conventional cooling technologies into hybrids is to risk energy and fuel consumption offsets that defeat the purpose of the hybrid approach. Directed cooling using personal cooling systems is an ideal solution for construction equipment, delivery vehicles, and the wide gamut of industrial transportation applications where hybrid vehicles are expected to bring huge benefits. By providing operator and passenger comfort at a vastly reduced level of energy consumption, we allow these hybrid technologies to live up to their full potential while ensuring that they are accepted as safe and comfortable to operate.

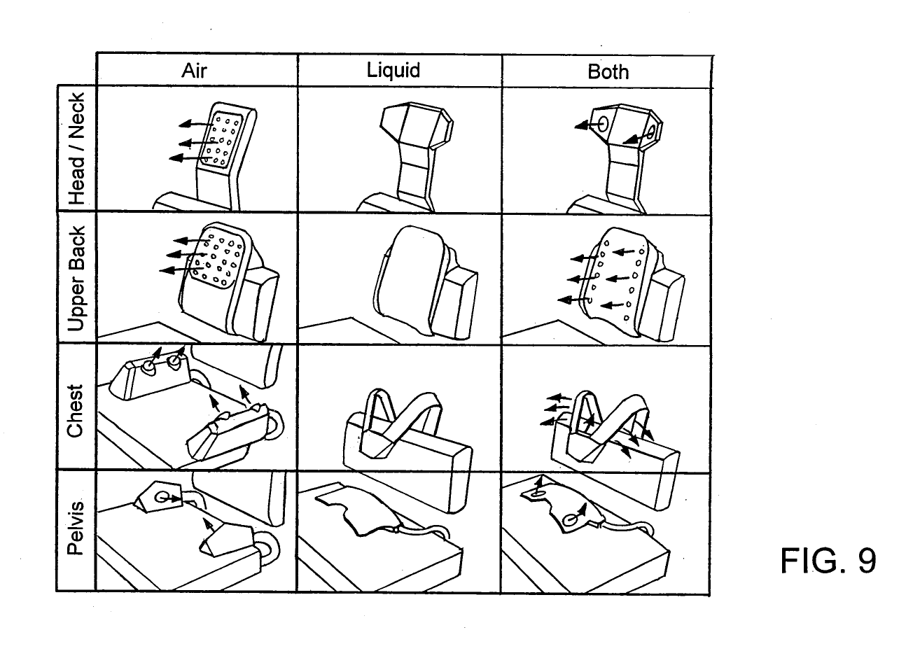

Many variations are possible for configuration shown in the figures and described above. There may be a greater or lesser number of ducts and vents provided, and the ducts and vents may be located in different locations to cool different parts of a user's body. There may be additional contact cooler plates (of any of various suitable surface shapes) to cool other parts of the user's body. The head, neck, chest, upper back and pelvis are the major thermal dissipation zones of a human. FIG. 9 shows many alternative configurations, where the cooling is provided by directed components to apply cooling directly to the thermal dissipation zones of the human body, particularly the head/neck, chest, upper back, and pelvis. The cooling system may employ forced air (which may be cooled), contact or liquid cooling, or a combination of both.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A personal cooling system for a vehicle user comprising:
a contact cooler that contacts the vehicle user;
a forced-air cooler that directs cooled air to the vehicle user; and
a recirculating fluid system that is operatively coupled to both the contact cooler and the forced-air cooler to provide cooling to both the contact cooler and the forced-air cooler.

2. The personal cooling system of claim 1, wherein the contact cooler is integrated with a back of a seat of a vehicle, to contact the back of the vehicle user when the vehicle user is in the seat.

3. The personal cooling system of claim 2, further comprising a removable back rest insulator that is placeable over the contact cooler, to provide insulation between the contact cooler and the back of the vehicle user.

4. The personal cooling system of claim 1,
wherein the recirculating fluid system includes:
a compressor;
a heat exchanger downstream of the compressor, for rejecting heat from the reticulating fluid system; and
an expansion device downstream of the heat exchanger; and
wherein refrigerant output by the expansion device provides cooling for the contact cooler and the forced-air cooler.

5. The personal cooling system of claim 4,
wherein the forced-air cooler includes:
a fan; and
one or more ducts;
wherein the fan blows air past an additional heat exchanger of the recirculating fluid system, cooling the air and directing the air through the one or more ducts, from which the air is directed to the vehicle user.

6. The personal cooling system of claim 5, wherein the one or more ducts includes a fixed seat duct that outputs air at a fixed seat vent located between a back of a seat of the vehicle, and a seat cushion of the seat.

7. The personal cooling system of claim 5, wherein the one or more ducts includes a pair of movable ducts that terminate in vents are configured to be located at different vent attachment points on a seat of the vehicle.

8. The personal cooling system of claim 7, wherein the different vent attachment points include one or more of the following:
a pair of seat cushion vent attachment points on opposite sides of a seat cushion of the seat;
a pair of arm rest vent attachment points on bottoms of arm rests of the seat;
a pair of back rest vent attachment points on opposite sides of a seat back of the seat; and
a pair of head rest vent attachment points on opposite sides of head rest of the seat.

9. The personal cooling system of claim 5, wherein the one or more ducts includes one or more head rest ducts that terminate in one or more head rest vents in a head rest of a seat of the vehicle.

10. The personal cooling system of claim 1, wherein the recirculating fluid system includes:
a compressor;
a heat exchanger downstream of the compressor, for rejecting heat from the reticulating fluid system; and
an expansion device downstream of the heat exchanger; and
wherein refrigerant output by the expansion device provides cooling for the contact cooler and the forced-air cooler;
wherein the forced-air cooler includes:
a fan; and
ducts;
wherein the fan blows air past an additional heat exchanger of the recirculating fluid system, cooling the air and directing the air through the one or more ducts, from which the air is directed to the vehicle user,
wherein the ducts include:
a fixed seat duct that outputs air at a fixed seat vent located between a back of a seat of the vehicle, and a seat cushion of the seat;
a pair of movable ducts that terminate in vents are configured to be located at different vent attachment points on the seat; and
one or more head rest ducts that terminate in one or more head rest vents in a head rest of the seat;
wherein the different vent attachment points include one or more of the following:
a pair of seat cushion vent attachment points on opposite sides of a seat cushion of the seat;
a pair of arm rest vent attachment points on bottoms of arm rests of the seat;
a pair of back rest vent attachment points on opposite sides of a seat back of the seat; and
a pair of head rest vent attachment points on opposite sides of head rest of the seat; and
wherein the contact cooler is integrated with the back the seat, to contact the back of the vehicle user when the vehicle user is in the seat.

11. The personal cooling system of claim 1, in combination with a seat of the vehicle, wherein the personal cooling system is integrated with the seat.

12. The combination of claim 11, as part of the vehicle, wherein the vehicle is an open-cab vehicle.

13. The combination of claim 12, wherein the open-cab vehicle is a cabless vehicle.

14. A method of cooling a user of an open-cab vehicle, the method comprising:
providing a seat of the open-cab vehicle; and
providing cooling to the user sitting in the seat, using a personal cooling system that is integrated with the seat.

15. The method of claim 14, wherein the providing cooling includes providing cooling from a forced-air cooler of the personal cooling system that directs cooled air to the vehicle user.

16. The method of claim 15, wherein the force air cooler includes a pair of movable ducts that terminate in vents that are configured to be located at different vent attachment points on the seat.

17. The method of claim 15, wherein the providing cooling also include providing cooling form a contact cooler of the personal cooling system that provides cooling to a back of the user through contact.

18. The method of claim 14, wherein the providing cooling includes providing a level of cooling that is a function of one or both of an outside (ambient) temperature, and a weight of an occupant of the seat.

19. A method of cooling a user of a vehicle, the method comprising:
detecting the user occupying a seat of the vehicle;
upon detection of the user occupying the seat, providing a relatively high level of cooling to the user for a predetermined time interval, using a personal cooling system; and
after the predetermined time interval, reducing the level of cooling provided by the personal cooling system to a relatively low level of cooling.

20. The method of claim 19,
wherein the providing the relatively high level of cooling includes providing 0.75 tons or more of cooling for 30 seconds to 120 seconds; and
wherein the reducing the level of cooling to 0.5 tons of cooling or less.

21. The method of claim 19, wherein the personal cooling system includes:
a contact cooler that contacts the vehicle user;
a forced-air cooler that directs cooled air to the vehicle user; and
a recirculating fluid system that is operatively coupled to both the contact cooler and the forced-air cooler.
